(19) United States
(12) Patent Application Publication
(10) Pub. No.: US 2002/0074793 A1
(43) Pub. Date: Jun. 20, 2002

(54) Combination postcard-business card/rotary card mailer systems and methods

(76) Inventors: Tracey L. Glenn, Altadena, CA (US); Jenny C. Feng, Claremont, CA (US); Richard Andrew Doyon, Santa Monica, CA (US); Peter Sperl, Miesbach (DE)

Correspondence Address: DOUGLAS N. LARSON, ESQ., OPPENHEIMER WOLFF & DONNELLY LLP, 2029 Century Park East, Suite 3800, Los Angeles, CA, 90067, US

(21) Appl. No.: 09/864,932

(22) Filed: May 24, 2001

Related U.S. Application Data
(60) Provisional application No. 60/207,493, filed on May 26, 2000.

(51) Int. Cl. B42D 15/00

(52) U.S. Cl. 283/62

(57) ABSTRACT

A pattern of horizontal and vertical perforation lines are cut into a sheet to define a pair of combination mailers with a disposable sheet margin around them and a sheet margin between them. Other formats aside from this “two-up” format can be used if desired. Each of the mailers includes a postcard connected to and adjacent either a business card or a rotary card. The user then designs on his computer the desired indicia to be printed on the postcard and the business card or rotary card of each of the mailers on the sheet. The sheet is then passed through a printer and the selected indicia printed on the mailers. The sheet can have a calendered infeed end to improve printer pickup and feed. The printed mailers are then separated from the sheet along the perforation lines, stamped and mailed to the intended recipients. The recipients then separate the custom printed business or rotary card from the postcard and retain the separated card for future reference.

### RELATED APPLICATION

This Application claims priority of U.S. Provisional Application No. 60/207,493 filed May 26, 2000, which is hereby incorporated by reference in its entirety.

### GENERAL BACKGROUND

The present invention relates to constructions, systems and methods for making and using combination postcard-business card mailers and combination postcard-rotary card mailers.

When announcements are sent in the mail such as by businesses to prospective customers, the announcements are typically discarded by the prospective customers. There is thus a need for a system which encourages the prospective customers to keep the announcements or portions thereof containing information on the business and preferably which can be designed and printed by the business on a personal computer system.

### SUMMARY OF THE INVENTION

Directed to solving the problems and meeting the needs in the prior art, disclosed herein are perforated sheet constructions of the present invention. One embodiment has the perforation lines forming two combination postcard-business card mailers, and the lines of the other form two combination postcard-rotary card mailers on the sheet. The user custom designs on his personal computer the indicia to be printed on front and back sides of the postcard portions and the business or rotary card portions of each of the combination mailers on the sheet. The indicia on the postcard portions can be oriented perpendicular to that on the business or rotary card portions.

Each of the sheets is preferably calendered at its infeed end to assist in feeding the sheet into the user's printer. The user then instructs the printer to print the custom-designed indicia on the two combination mailers. The printed combination mailers are then separated from the surrounding sheet material and from each other along the perforation lines. Stamps can be applied to the postcard portions and the combination mailers mailed to desired recipients. The recipients will then read the messages printed on the mailers, separate the custom-printed business card or rotary card from the postcard along the perforation lines separating them, and keep the cards with the user's (advertising) information thereon.

In other words, the present invention provides for a system where the postcard announcement can be sent to the recipients, and attached thereto is a business card or rotary card with the business's identifying information, such as name, address, phone number, fax number, e-mail address, logo and so forth, as are typically provided on such cards. These cards would be separable from the announcements by the recipient such as by tearing along a perforation or other weakened separation line. The separated, printed cards then are of a traditional size and shape and adapted to be retained by the recipient such as by placing in his rotary card file or in a business card box or album. Thus, instead of the recipient throwing away the mailer that he receives in his post box, he advantageously retains a portion thereof as a traditional business card or rotary card with the desired identifying information of the sender.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a front view of a combination postcard-business card mailer sheet of the present invention;

FIG. 2 is a front view of a combination postcard-rotary card mailer sheet of the present invention;

FIG. 3 is an enlarged cross-sectional view taken along line 3-3 of FIG. 1 of a combination postcard-business card mailer sheet of the present invention;

FIG. 4 is a flow chart of a process of the present invention for making and using either of the embodiments of FIGS. 1 and 2;

FIGS. 5-9 are first, second, third, fourth and fifth computer screenshots, which can be used in the process of FIG. 3;

FIG. 10 is a flow chart of an alternative process of the invention;

FIG. 11 illustrates a system for making combination postcard-business card mailer sheets of the present invention; and

FIG. 12 is a perspective exploded view of a packaged mailer system of the present invention.

### DETAILED DESCRIPTION OF THE PREFERRED EMBODIMENTS

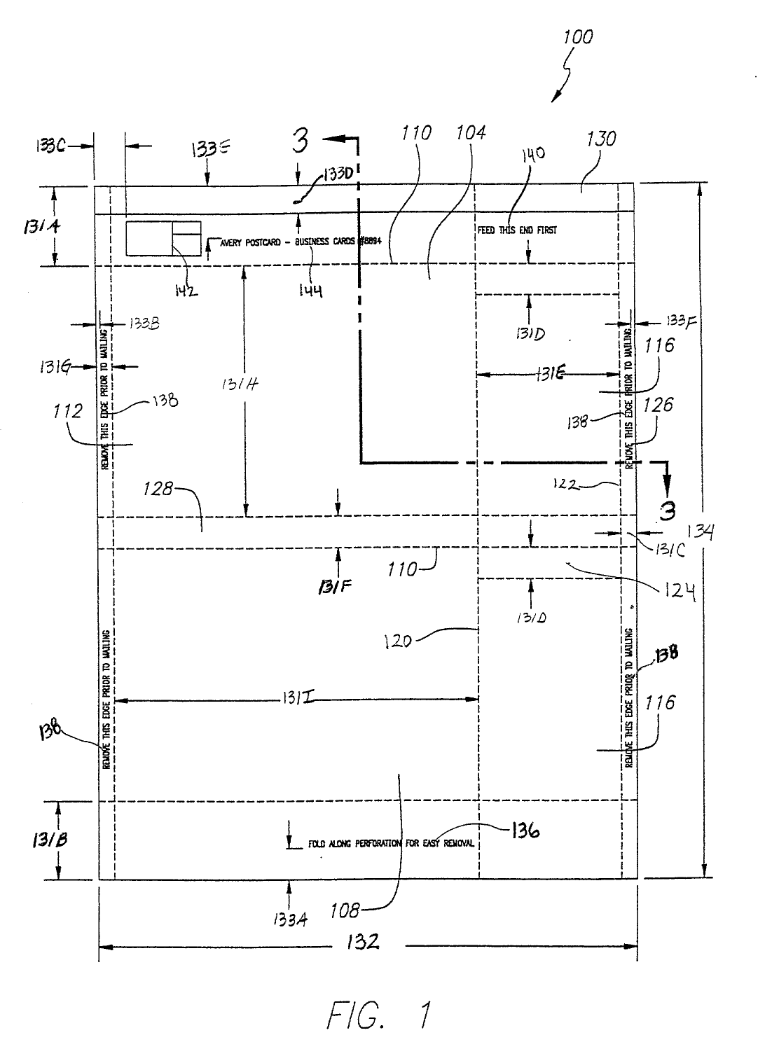

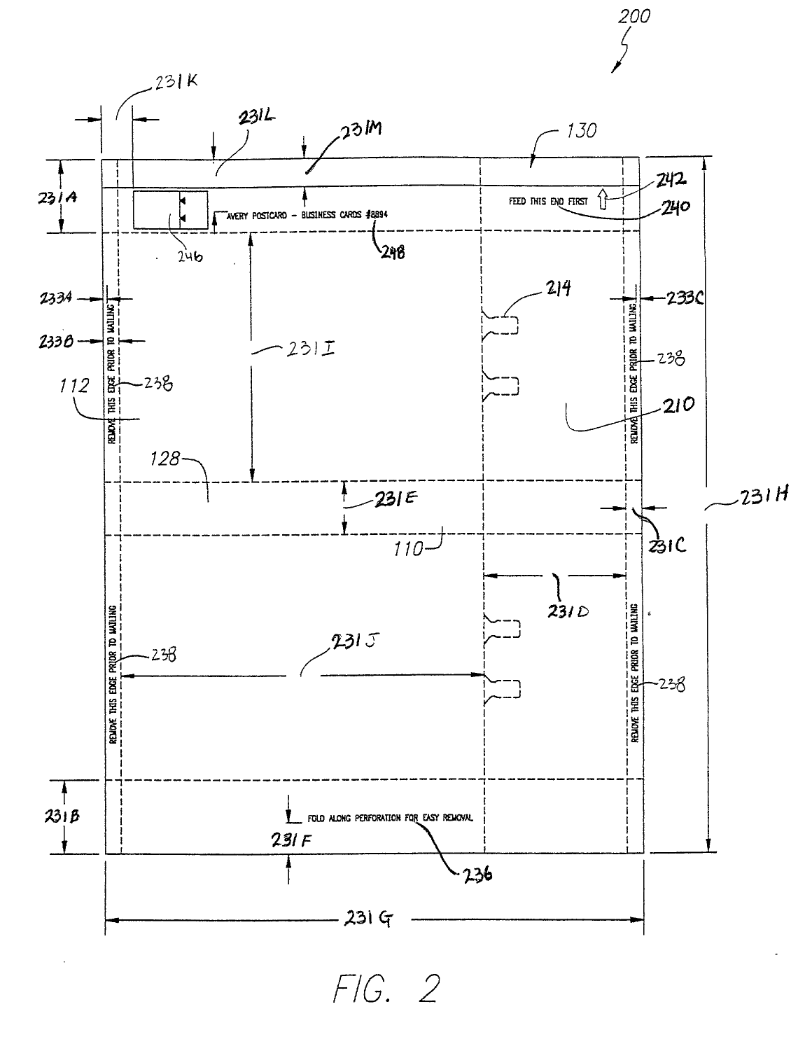

A number of different embodiments of the present invention as well as processes for using and making them are disclosed herein and will now be described. FIGS. 1 and 2 are front or top plan views of alternative sheet constructions of the present invention. The sheet construction of FIG. 1 shown generally 100 is a combination postcard-business card mailer and shows two mailers formed thereon at 104 and 108 by perforation lines 110. Both are identical with one positioned above the other. Each includes a postcard 112 and a business card 116 adjacent thereto and separated by a perforation line 120. A disposable rectangular portion 124 is positioned at the end of the business card and adjacent to the postcard. This is a disposable paper portion, provided because the business card has a length of three and one-half inches while the postcard has a length or width of four inches. This allows a rectangle to be formed by the horizontal 110 and vertical 120 perforation lines.

Each of the combination mailers is surrounded by a margin or edge 126, and a gutter portion 128 separates the two of them. The edges and gutter portions protect the edges of the mailers 104, 108 and also provide for the desired dimensions of the combinations within the overall 8½×11 inch dimension of the sheet construction 100 (132=8½ inch; 134=11 inch). The preferred dimensions for the perforation lines are as follows: 131A=1¼ inch; 131B=1¼ inch; 131C=¼ inch; 131D=½ inch; 131E=2 inch; 131F=½ inch; 131G=¼ inch; 131H=4 inch; 131I=6 inch. Additional preferred dimensions include: 133A=½ inch; 133B=3/32 inch; 133C=½ inch; 133D=7/16 inch; 133E=¾ inch; 133F=3/32 inch. Instructional printing on the sheet construction assists the user in using this product. For example, printed text indicating instructions for folding 136 and removal of bordering edges 138 along perforated portions of the sheet construction aids the user in separation of the sheet construction to form a postcard 108 and a business card 116. Instructional printing 140 also indicates an infeed end 130 of the sheet construction. Additionally, diagrammatic indicator 142 as well as product code number 144 printed on a non-postcard non-business card region of a sheet construction identify the type of sheet construction to the user.

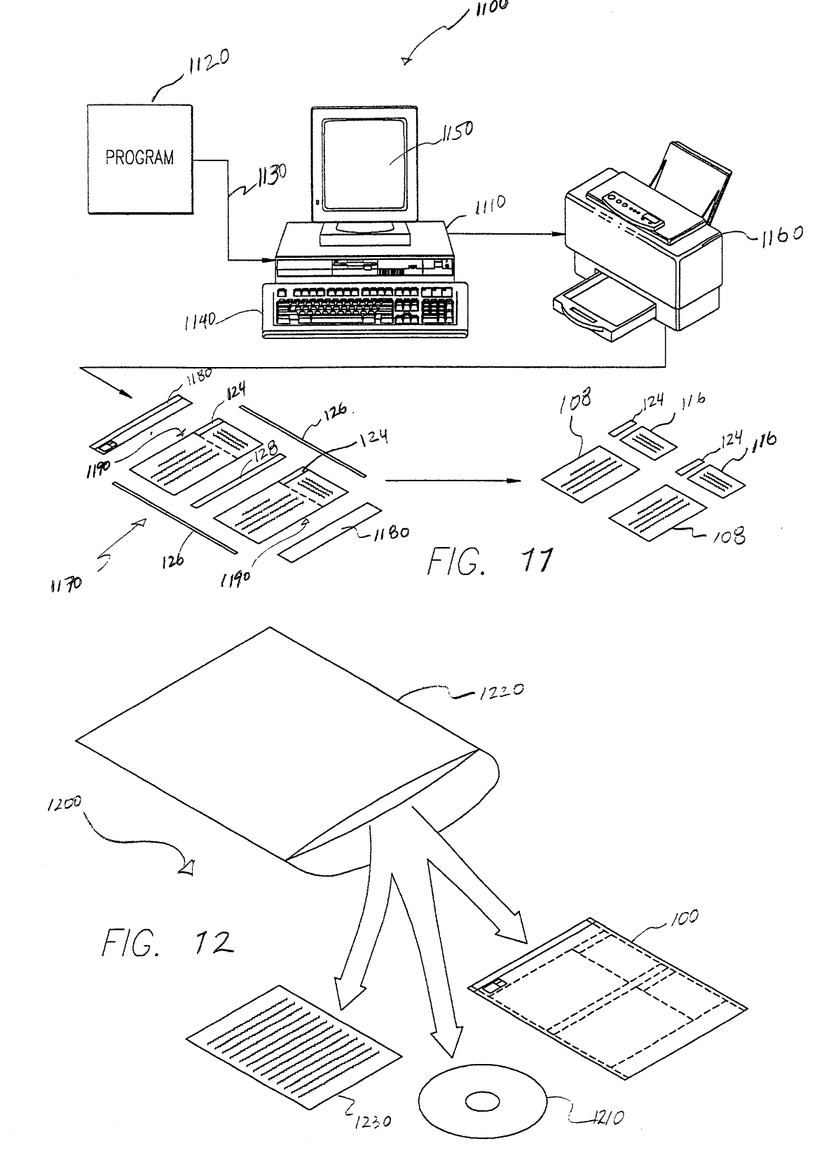

Further, the forward or infeed ends 130 of the sheet constructions may be calendered about twenty-five percent to assist in the feeding of the sheet 100 into the printer (shown in FIG. 11) for a printing operation. The printing can be on both sides of the postcard and/or both sides of the business card. One preferred embodiment includes the printing or indicia on the postcard to be in the portrait direction of the sheet that is running from left to right in FIG. 1, with the printed indicia on the business card oriented in the opposite landscape direction, that is, up and down relative to FIG. 1.

The sheet construction 200 of FIG. 2 is similar to sheet construction 100 except that instead of a business card, a rotary card 210 is provided with the rotary card punch out slots 214 illustrated. The rotary card 200 preferably will be the same length as the width of the postcard and therefore the small disposable rectangle may not be needed. The preferred dimensions for the perforation lines are as follows: 231A=1 inch; 231B=1 inch; 231C—¼ inch; 231D=2⅛ inch; 231E=1 inch; 231F=7/16 inch; 231G=8½ inch; 231H=11 inch; 231I=4 inch; 231J=5 13/16 inch; 231K=½ inch; 231L=⅝ inch; 231M=7/16 inch. Additional preferred dimensions include: 233A=3/32 inch; 233B=¼ inch; 233C=3/32 inch. A postcard/rotary card type of sheet construction also has instructional printing to assist a user in using this product. For example, printed text indicating instructions for folding 236 and removal of bordering edges 238 along perforated portions of the sheet construction aids the user in separation of the sheet construction to form a postcard 112 and a rotary card 210. Instructional printing 240 and directional arrow 242 also indicates an infeed end 130 of the sheet construction. Additionally, diagrammatic indicator 246 as well as product code number 248 printed on a non-postcard or non-rotary card region of a sheet construction identify the type of sheet construction to the user.

A preferred material for the sheet constructions 100, 200 is a cardstock material weighing approximately one hundred and sixty grams per square meter with a thickness of at least 0.008 inch and a color optimized coating on both sides that enhances the appearance of ink applied by a typical desk top inkjet printer. An alternative card stock material weighs approximately one hundred and forty grams per square meter with a minimum thickness of 0.007 inch and has no color optimizing coating.

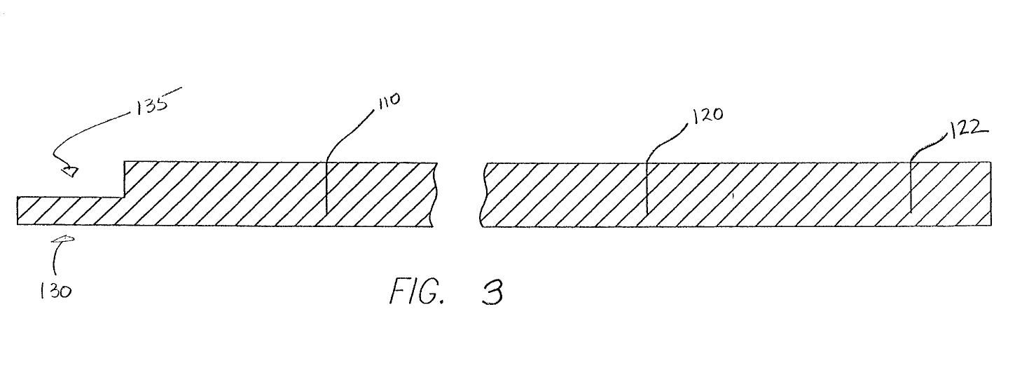

Referring to FIG. 3, a cross-sectional view taken along line 3-3 of FIG. 1 of a sheet construction is provided. The infeed edge 130 of FIG. 1 is calendered 135 as shown in the cross section view provided in FIG. 3. As described previously, the calendering assists in feeding of the sheet 100 into a printer for a printing operation. Perforation lines 110, 120 and 122 are indicated in FIG. 3. These perforation lines correspond to the same perforation lines as shown in the plan view of the sheet construction 100 provided in FIG. 1. The preferred perforation or micro-perforation dimensions are 0.020 inch cut with a 0.007 inch tie. Additional ties of 1/32 inch at key points to ensure that the business card, rotary card and rotary card punch-outs do not detach from the postcard during the mailing process can be provided. That is, additional (wider) ties can be included at key areas around the business card and rotary card to prevent premature separation from the postcard, while passing through the U.S. Postal Service. The cut and tie dimensions depend on the physical properties of the material, the perforation pattern, the overall strength (to prevent premature separation in desktop printers), ease of separation and appearance of the card after separation. Alternative perforation dimensions are cut and tie dimensions of 0.013 inch/0.005 inch; 0.010 inch/0.005 inch; and 0.125 inch/0.09375 inch.

Preferred and alternative micro-perforation lines and dimensions have been described. However, it is also within the scope of the invention to provide for other types of weakened separation lines such as scored lines, from one or both sides of the sheet, perforation lines from both sides of the sheet, or other means as would be apparent to those skilled in the art. If the mailer combination is intended to be sent through the U.S. Postal Service, the weakened separation lines between the postcard and the business card 116 or rotary card 210 should be adapted to survive the delivery service and to be in compliance with any postal regulations.

The sheet constructions 100, 200 are fed into printers so that the indicia as custom designed by the user as will be apparent from the flow charts herein, can be printed thereon. Examples of the printers are the following inkjet printers: Hewlett Packard-DeskJet Models 560C, 694C, 722C and 870C; Canon-BJC Models 600 and 4200; Epson-Stylus Color Models II and 600; and Lexmark Model 1020.

Instead of printing the product in a desktop printer, alternative indicia applying methods include handwriting information or having it professionally printed, that is, offset printed. A further alternative is to have the indicia on adhesive labels, which are adhered to the mailer.

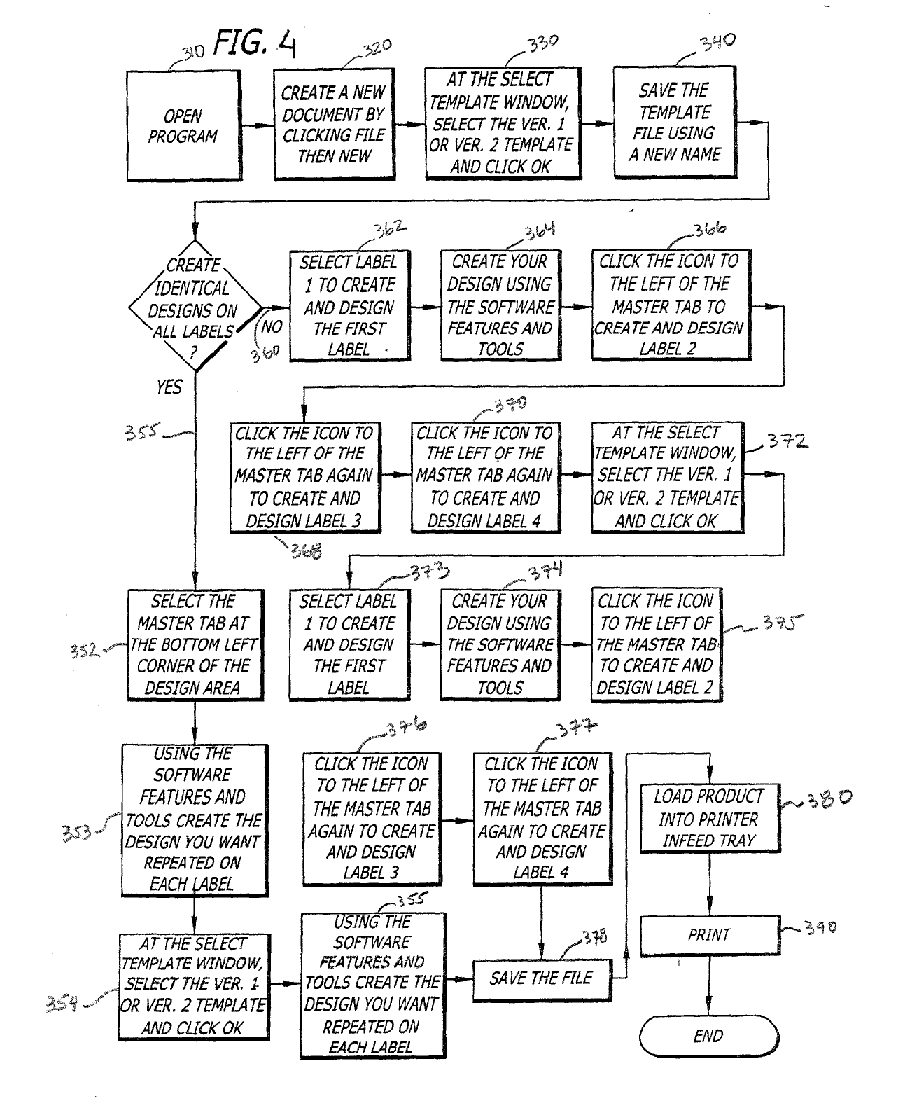

FIG. 4 shows software instructions for the sheet constructions of FIGS. 1 and 2. References to version 1 (“VER.1”; product code 8824) and version 2 (“VER. 2”; product code 8894) are to the rotary card embodiment of FIG. 2 and the business card embodiment of FIG. 1, respectively. The labels 1, 2, 3 and 4 refer, respectively, to postcard front, business card front, postcard back, and business card back.

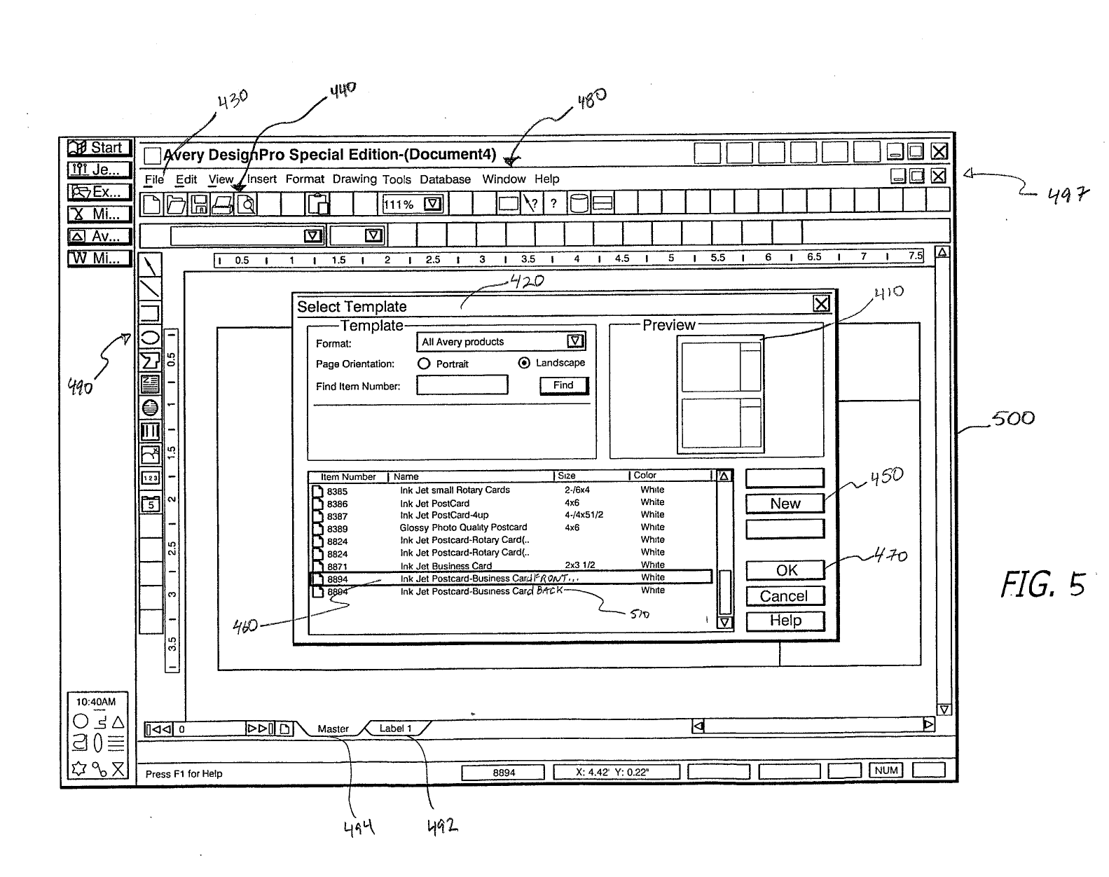

To help in the understanding of the flow chart, various screen shots are provided as FIGS. 5-9. For each of them, the front view or the front of the card is defined as the message side. This is the side where the consumer would design the business card and the postcard. In contrast, the back view or the back of the card is defined as the address side where the consumers would place the address and the stamp.

FIG. 5 is a screen shot showing how a new template is selected. Upon opening the program (See also block 310 of FIG. 4), the user creates a new document by clicking on the File drop down menu 430 in the tool bar 440. Located above the tool bar 440 region are also drop-down menu or function items 480 which contain further formatting, editing or other type of control functions of the program are also located along the upper 497 horizontal region of the general program window 500. In the pop-up Select Template window 420, the user clicks NEW 450, then selects a template by clicking on the desired template 460. A preview of the template is available on the upper right hand corner of the pop-up box 410. When the item number has been selected, the user clicks OK 470. Additional drawing, editing and other design functions are indicated by further operative buttons 490 located along a vertical toolbar. Selection tabs 492 and 494 allow the user to toggle between different layers of design.

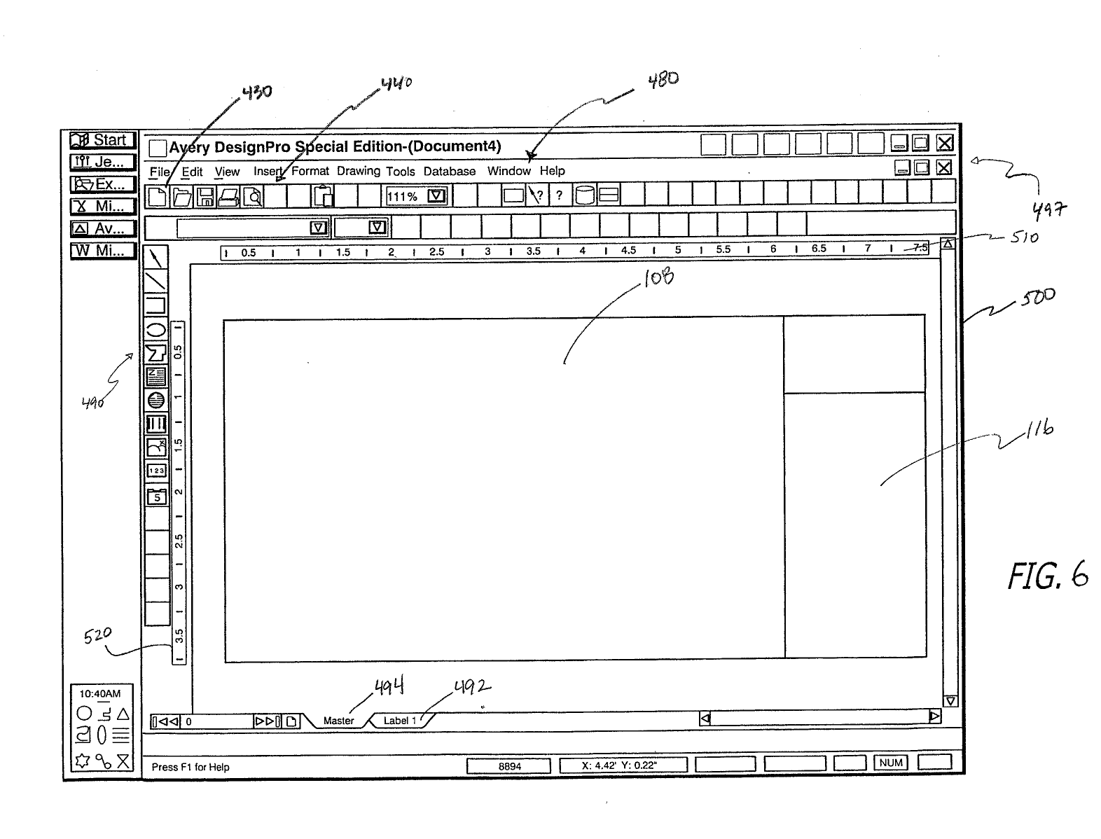

FIG. 6 is a front formatting view of a postcard/business card template (the version 1, or product 8894 template). This screen allows the consumer to incorporate graphics and text on the front of the postcard 108 and business card 116 card. He can get to this screen by clicking NEW in the tool bar and then clicking on the item number 8894 (See FIG. 4). Drawing, editing and other design functions are indicated by operative buttons 490 located along a horizontal 440 or vertical 490 toolbar region. Located above the tool bar 440 region are also drop-down menu or function items 480 which contain further formatting, editing or other type of control functions of the program located along the upper 497 horizontal region of the general program window 500. A horizontally oriented 510 and vertically oriented 520 ruler bar are also provided to aid the user in label design. Selection tabs 492 and 494 allow the user to toggle between different layers of design of a label.

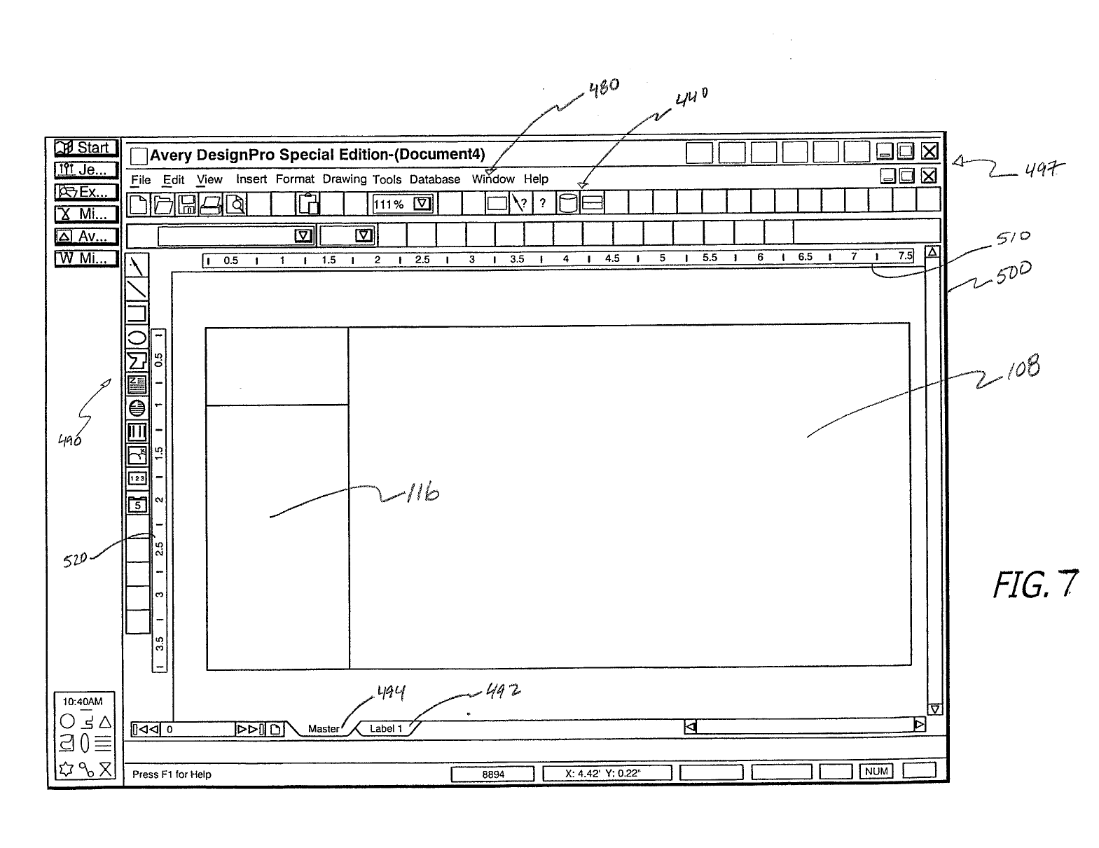

FIG. 7 is a back formatting view of the postcard/business card template (the version 1 or product 8894 template). This screen allows the consumer to incorporate graphics and text on the back of the postcard 108 and business card 116. The consumer can get to this screen by clicking on NEW in the tool bar and then clicking on the item number 8894 Back template (See FIG. 5, 510). Drawing, editing and other design functions are indicated by operative buttons 490 located along a horizontal 440 or vertical 490 toolbar region. Located above a horizontal tool bar 440 region are also drop-down menu or function items 480 which contain further formatting, editing or other type of control functions of the program located along the upper horizontal region 497 of the general program window 500. A horizontally oriented 510 and vertically oriented 520 ruler bar are also provided to aid the user in label design. Selection tabs 492 and 494 allow the user to toggle between different layers of design of a label.

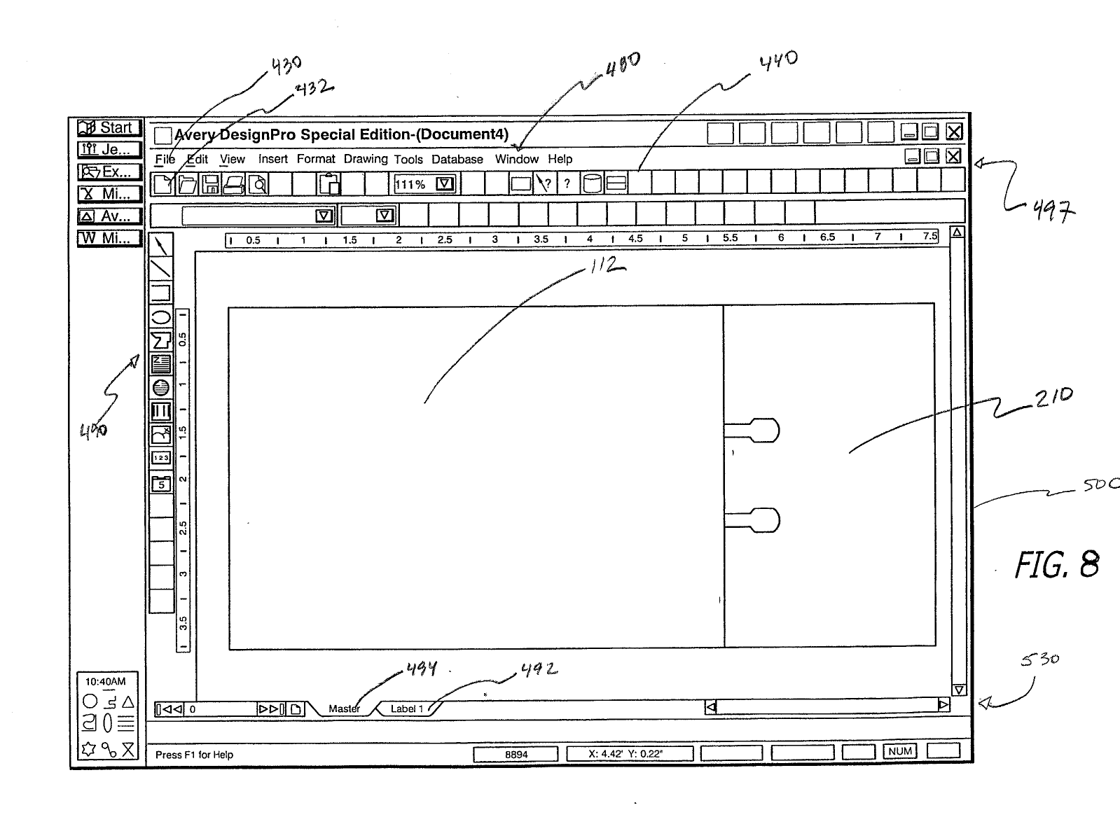

FIG. 8 is a front formatting view of the rotary card template (the version 2, or product 8824 template) This screen allows the consumer to incorporate graphics and text on the front of a postcard/rotary card mailing sheet. The postcard 112 and rotary card 210 are represented as shown in FIG. 8. The consumer can get to the screen by clicking File 430 and then selecting NEW (not shown) at the pull-down menu or by clicking on the new icon 432 in the tool bar and then clicking on item 8824 at the Select Template window (not shown). As described previously, drawing, editing and other design functions are indicated by operative buttons 490 located along a horizontal 440 or vertical 490 toolbar region. Located above the tool bar 440 region are also drop-down menu or function items 480 which contain further formatting, editing or other type of control functions of the program located along the upper 497 horizontal region of the general program window 500. A horizontally oriented 510 and vertically oriented 520 ruler bar are also provided to aid the user in label design. Selection tabs 492 and 494 are located along the lower horizontal 530 region of the general program window 500.

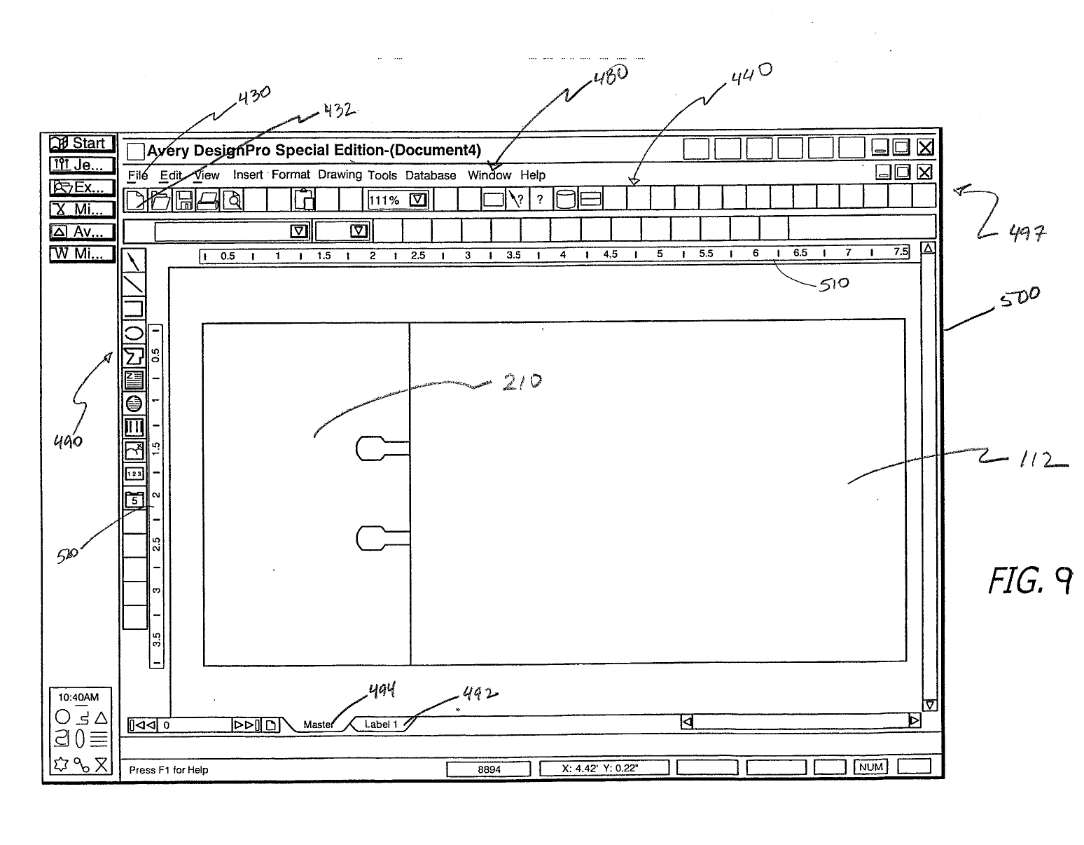

FIG. 9 is a back formatting view of a postcard/rotary card template (the version 2 template). The screen allows the consumer to incorporate graphics and text on the back of the postcard 112 and rotary card 210. To get to this screen the consumer clicks on NEW in the tool bar and then clicks on item 8824 in the Select Template window (See FIG. 5, 420). The consumer can get to this screen by clicking on File 430 and then selecting NEW (not shown) at the pull-down menu or by clicking on the new icon 432 in the tool bar and then clicking on item 8824 at the Select Template window (not shown). As described previously, drawing, editing and other design functions are indicated by additional operative buttons 490 located along a horizontal 440 or vertical 490 toolbar region. Located above the tool bar 440 region are also drop-down menu or function items 480 which contain further formatting, editing or other type of control functions of the program located along the upper 497 horizontal region of the general program window 500. A horizontally oriented 510 and vertically oriented 520 ruler bar are also provided to aid the user in label design. Selection tabs 492 and 494 are located along the lower vertical 530 region of the general program window 500.

Referring to FIG. 4, the following steps can be followed to format and print Promotion Mailers using the software tools of this invention.

1. Open Program 310.

2. Click File>New 320.

3. At the Select Template windows, select the VER. 1 or VER. 2 template 330. Click OK. There are two templates, Front and Back, for each product (See FIG. 5, for example 420 and 510).

4. Click File>Save As. Name and save the file 340. This allows the user to save his work regularly by going to File>Save or using Ctrl S on a computer keyboard (not shown).

5. The user should then familiarize himself with the program or software features, the Menu bar and the Toolbar. Many of these features and tools are similar or the same as those found in other programs.

6.

a. Creating identical designs (or design elements on all labels 350:

The Master tab at the bottom left corner of the design area is selected 352. Using software features and tools, the design to be repeated on each label is created 353. For example, the user can use this feature to include his return address on the postcard, create identical business cards or create identical labels.

To design the back of labels having identical designs, after selecting the appropriate Back template, at the Select Template window, the user chooses either the VER. 1 (See also FIG. 5, 510) or VER. 2 (not shown) 354. Using the program or software features and tools, the user creates the design and graphics desired on the back of each label 355.

b. Creating different designs on each label 360:

Label 1 is selected to create and design the first label 362. Create a design using the software features and tools 364. Next, click the icon to the left of the Master tab to create and design Label 2 366. To create Label 3, click the icon again 368, 370, etc, until the number of desired Front labels are created.

The word “Label” is used generically even though it refers to a card product. For these products a “Label” refers to one component of each design.

7. Repeat the steps above (330-370) to design the back of the product 372 (See FIGS. 7 and 9 for representative screen views). This time, at the Select Template window, choose the VER. 1 (See also FIG. 5, 510) or VER. 2 (not shown) for creating identical designs on all labels 350 or for creating non-identical designs on all labels 360. To create the back of labels not having identical designs, after selecting the appropriate Back template, select Label 1 to create and design the back of the first label 373, using the software features and tools 374 of the program. To design another label, the user clicks on the icon to the left of Master to create Label 2. The icon to the left of Master tab is clicked again 376 to create and design Label 3, and again to create and design Label 4 377. The user repeats steps 373-377 until the number of desired labels with different designs is made.

8. The files are saved 378.

9. To print the card products with the file open, select File>Print Preview, and the design is checked. Click Close. Make any necessary adjustments to your design.

10. The user inserts a plain sheet of paper into his printer 380. He selects File>Print, checks his printer settings and changes the Page Orientation to Portrait. Click OK to print 390.

11. When the user is satisfied the test print matches the layout of the practice sheet (included in the package), he inserts the card product 100 or 200 into his printer. Click File>Print. Select how many labels (postcard combinations) to print and click OK. When printing the Back of his product, change the Page Orientation to Portrait and be sure to insert the correct end of the card product into the printer.

A further alternative is to have the software or template designated in general publishing software such as that as might be available from Microsoft, Adobe Photoshop, Quark Express and the like.

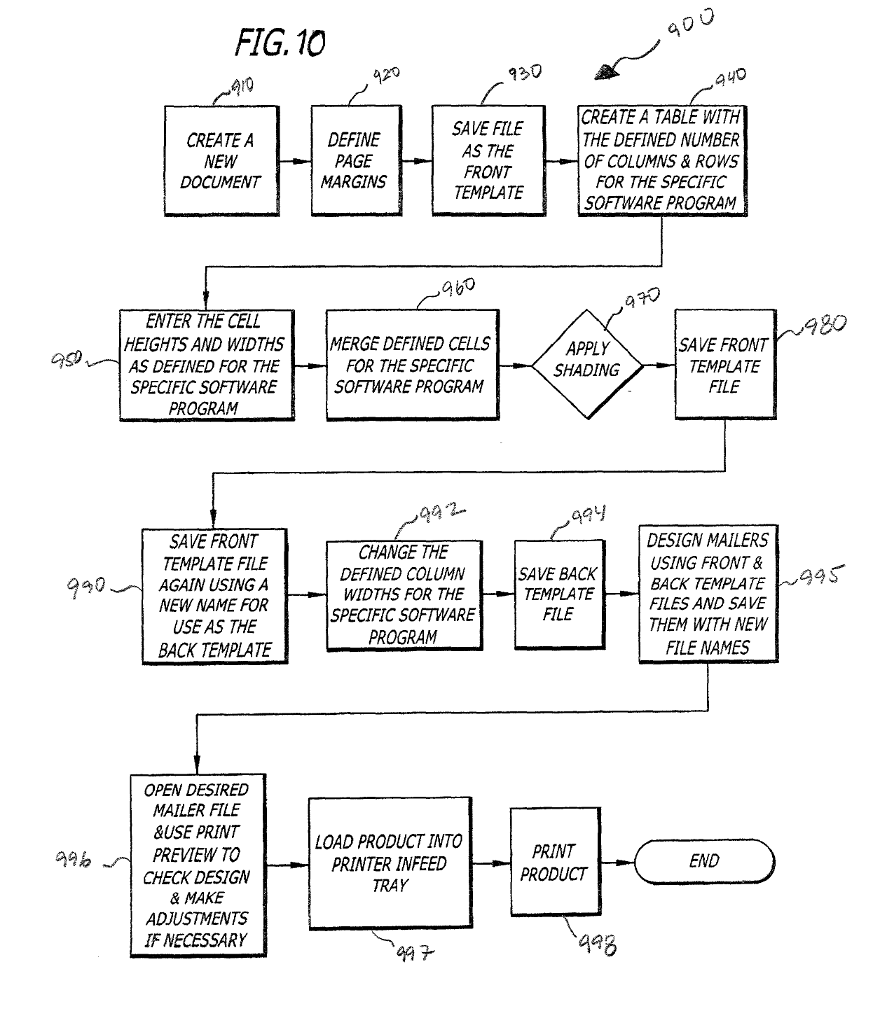

FIG. 10 shows alternative software instructions including formatting and printing tips for the sheet constructions of the present invention. Generally at 900, the following steps can be followed to format and print Promotion Mailers using the software tools of this invention. Therefore, the present invention can be used with other available software such as Microsoft Word, WordPerfect or Microsoft Publisher, or any other available publishing or word processing program.

1. Open Program and create New document 910.

2. Define page margins 920.

3. Click File>Save As 930. Name and save the file as front template, if appropriate. This allows the user to save his work regularly by going to File>Save or using Ctrl S.

4. A table including defined number of columns and rows for the specific software program used is created 940.

5.

a. Desired cell heights and widths as defined for the specific software program or tool used are entered 950.

b. Using software features and tools, the defined cells are merged 960 and shading applied as depicted by block 970.

c. The file is saved as a Front Template file 980.

6. Repeat the steps above and save as a new file to design the back of the product 990.

7. If necessary, the defined column widths for the specific software program used is adjusted or changed 992 and the Back Template file saved 994.

8. Mailers can now be designed as desired by the user using front and back template files created in the above steps and saved under new file names. Any necessary adjustments to a design can be made as desired 996.

9. The user inserts a plain sheet of paper into his printer 997. He selects File>Print, checks his printer settings and product is printed 998.

Of course, the present invention also includes systems for executing the exemplary software and tools described above. An exemplary system 1100 is illustrated in FIG. 11. Although the exemplary software tools may be stored upon any type of storage device or storage medium, the exemplary software tools may also be stored on, for example, portable computer-readable media, such as floppy disks, tape, or optical storage media; the software tools may also be stored on a computer hard drive 1110 or on remote storage, such as in a database resident on a remote server 1120 accessible over Internet 1130 or other communications network.

Users of the exemplary system interact with the software tools by an input device 1140, which may include but is not limited to computer keyboards, graphical user interfaces operable by mouse or touch-screen, voice activation, or telephone touch-tone input. The exemplary system further comprises a computer display device 1150 viewable by the user. The custom designed mailer sheets of the present invention can then be printed by feeding the construction sheets into a printer 1160 so that the indicia as custom designed by the user can be printed, then detached 1170. The margin or edge 126 and gutter portion 128 as well as other edge portions 128 and 1180 are removed from each postcard/business card assembly 1190, to form personalized postcards 108 and business cards 116 or postcard and rotary cards (not shown) as desired.

Referring to FIG. 12, the present invention also provides a kit or mailer system 1200 packaged so as to include construction sheets and software allowing a user to design and print on a personal computer system the indicia on the mailer. For example, a mailer system can include storage media containing a program or software tools as shown in the flow chart of FIG. 3. The program can be provided on a CD 1210 included in a package 1220 also containing sheet constructions 100. For example, fifty sheet constructions, each having two mailers thereon, can be provided in the packaging together with an instruction sheet 1230. Alternatively, instead of providing the software on a CD, the software can be provided to a consumer on a floppy disk. Or, the software can be downloaded by the consumer from an Internet site. In other words, the template can be downloaded onto base software such as Avery DesignPro 2000, Microsoft Publisher or Broderbund The Print Shop.

Of course, a kit or mailer system of the present invention can also include using the construction sheets with other commercially available publishing or word processing programs. Therefore, an instruction sheet can be a tip guide including software and/or printing tips which aid the user in designing and printing personalized indicia on a mailer using base software such as, for example, Microsoft Word, Microsoft Publisher, WordPerfect or the like.

Tips for Using Software Tools

Referring to FIG. 5:

a. to view sample card designs, from the menu bar a user can click on File>Open 430, then double click on Samples folder and then click on Cards (not shown). (It may be necessary to navigate to the Samples folder on, for example, a DesignPro CD or other appropriate software program. When he clicks File>Open, he will not automatically go to this location.)

b. A user can also use a F1 key or select Help>DesignPro Help from a Menu bar for information on specific software features such as, DesignPro features and tools.

c. The cursor can also be held over each tool of a Toolbar to display its function.

d. Graphics may be inserted by clicking on a Insert Picture icon on the Toolbar.

e. If desired, a user can also access storage media containing software tools, such as a DesignPro CD to access and/or insert graphics files that are available with, for example, a DesignPro Special Edition software package. In the Graphics folder, .wmf Clipart and .jpg Photo files can be found.

f. A design element may also, if desired, be moved from one label to another by selecting it and dragging it to the desired Label tab you want to move it to. This can be accomplished, for example, by holding the Ctrl key while dragging to copy the element.

g. With an object selected, (text or picture box), a user may select the Rotate tool to rotate the object. However, certain types of files, such as Windows Metafiles (.wmf) graphics included on, for example, the DesignPro CD cannot be rotated.

h. When more detailed designing is preferred, a user may turn off Snap to Grid to fine-tune the spacing of design elements (View>Snap to Grid).

i. Use of information contained in other files can also be accessed. For example, a user can select Database from the Menu bar to import and use a mailing list.

Sheet Construction Manufacturing Process

Preferred steps for manufacturing the sheet constructions 100, 200 will now be described. A roll of card material is loaded onto an unwind spindle of a converting press. The web material is threaded through the various printing, calendering, die-cutting/perforating and sheeting stations of the press. When the press is started, the web passes through the printing station where the desired artwork (product number, name, feeding directions, etc.) are printed on a top surface of the web. The web then passes through the calendering station where an edge of the web is compressed, reducing its thickness by approximately twenty-five percent.

The web then enters one of the perforation die stations where horizontal or vertical microperforation pattern is cut into the web. And the web next enters a second perforation station where the final horizontal or vertical microperforation pattern is cut into the web. Different stations for perforation die cutting the web in the horizontal and vertical directions may be useful, as different cutting pressures may be needed. Typically cutting parallel to the paper fibers in the machine direction is easier and requires less die cutting pressure, while cutting across the fibers requires more die pressure. And the web then goes through a sheeting station, which cuts the web into the final sheet size of eight-and-a-half by eleven inches. The finished sheets are then stacked and moved down a conveyor for placement into the desired package (packets or boxes). Preferably a stack of fifty sheets are placed with a CD containing the indicia design software and with an instruction sheet into retail packaging, and the package can then be shipped through normal distribution channels.

From the foregoing detailed description, it will be evident that there are a number of changes, adaptations and modifications of the present invention which come within the province of those skilled in the art. However, it is intended that all such variations not departing from the spirit of the invention be considered as within the scope thereof.

We claim:

1. A sheet construction, comprising:
a sheet having a plurality of weakened separation lines thereon defining an outline of a combination postcard-card mailer separable therealong from the rest of the sheet after indicia has been applied to the mailer wherein at least one of the lines defines a line of separation between a postcard and a card of the combination mailer.

2. The construction of claim 1 wherein the sheet includes a margin encircling the outline.

3. The construction of claim 1 wherein the sheet includes a sheet perimeter and the outline is spaced inwardly from the entire sheet perimeter.

4. The construction of claim 1 wherein the weakened separation lines are perforation lines.

5. The construction of claim 1 wherein the sheet has a calendered printer-infeed edge.

6. The construction of claim 1 wherein the combination postcard-card mailer defines a first combination postcard-card mailer, the postcard defines a first postcard and the card defines a first card, and the weakened separation lines also define an outline of a second combination postcard-card mailer separable therealong from the rest of the sheet after indicia has been applied to the second mailer, wherein at least one of the lines defines a line of separation between a second postcard and a second card of the second combination mailer.

7. The construction of claim 6 wherein the lines define a throw-away sheet strip between the first and second combination mailers.

8. The construction of claim 1 wherein card defines a rectangular business card, and the separation lines define a disposable small sheet rectangle positioned at an end of and adjacent to the postcard and at an end of and adjacent to the business card, whereby the combination mailer and the small sheet rectangle together define a rectangle on the sheet.

9. The construction of claim 8 wherein the small sheet rectangle is smaller than the business card and than the postcard.

10. The construction of claim 1 wherein the postcard is oriented in a portrait direction of the sheet and the card is oriented in a landscape direction of the sheet.

11. The construction of claim 1 wherein the indicia is applied to the postcard in a portrait direction of the sheet and the indicia is applied to the card in a landscape direction of the sheet.

12. The construction of claim 11 further comprising media containing program instructions allowing a user to design and print on a personal computer system the indicia on the postcard and the indicia on the card.

13. The construction of claim 1 further comprising a computer programmed to allow a user to design and print the indicia.

14. The construction of claim 1 wherein the card is a rectangular business card.

15. The construction of claim 1 wherein the card is a rotary card.

16. A mailer system, comprising:
a sheet having a plurality of weakened separation lines thereon defining an outline of a combination postcard-card mailer separable therealong from the rest of the sheet after indicia has been applied to the mailer wherein at least one of the lines defines a line of separation between a postcard and a card of the combination mailer; and
media containing program instructions allowing a user to design and print on a personal computer system the indicia on the mailer.

17. The system of claim 16 wherein the media is a CD.

18. The system of claim 16 wherein the indicia is printed on the postcard in a portrait direction of the sheet and the indicia is printed on the card in a landscape direction of the sheet.

19. The system of claim 16 wherein card is a rectangular business card, and the separation lines define a disposable small sheet rectangle positioned at an end of and adjacent to the postcard and at an end of and adjacent to the business card, whereby the combination mailer and the small sheet rectangle together define a rectangle on the sheet.

20. The system of claim 16 wherein the card is a rectangular business card.

21. The system of claim 16 wherein the card is a rotary card.

22. The system of claim 16 wherein the sheet includes a calendered printer-infeed end edge.

23. A method, comprising:
providing a sheet having a plurality of weakened separation lines thereon defining an outline of a combination postcard-card mailer separable therealong from the rest of the sheet after indicia has been applied to the mailer wherein at least one of the lines defines a separation line separating a postcard and a card of the combination mailer;
applying indicia on at least one of the postcard and the card; and
after the applying, separating the combination mailer from the rest of the sheet.

24. The method of claim 23 wherein the applying includes designing the indicia on a personal computer using a user's existing software.

25. The method of claim 23 wherein the applying includes designing the indicia on a personal computer using new software specific to the combination mailer.

26. The method of claim 25 wherein the new software is supplied to the user in a retail package with the combination mailers.

27. The method of claim 23 further comprising after the separating, mailing the combination mailer to a recipient.

28. The method of claim 24 further comprising the recipient separating the card from the postcard along the separation line.

29. The method of claim 23 wherein the applying includes passing the sheet through a printer which prints the indicia on the mailer.

30. The method of claim 26 wherein the sheet includes a calendered edge, and the passing includes feeding the sheet calendered edge first into the printer.

31. The method of claim 23 further comprising custom designing on a personal computer system the indicia.

32. The method of claim 23 wherein the indicia includes indicia on the postcard and indicia on the card.

33. The method of claim 23 wherein the indicia is printed by a printer on the postcard in a portrait direction on the sheet and on the card in a landscape direction on the sheet.

34. The method of claim 23 wherein the card is a rectangular business card.

35. The method of claim 24 wherein the card is a rotary card.

36. The method of claim 23 further comprising applying a stamp to the postcard.

37. A method of making a sheet construction, comprising:
forming on a web a plurality of weakened separation lines defining an outline of a combination postcard-business card mailer separable therealong from the rest of the web after indicia has been applied to the mailer wherein at least one of the lines defines a separation line between a postcard and a business card of the combination mailer; and
sheeting the web into a sheet which includes the outline.

38. The method of claim 37 wherein the weakened separation lines include perforation lines.

39. The method of claim 37 further comprising before the sheeting, printing on the web.

40. The method of claim 37 further comprising calendering the web.

41. A method of making a combination postcard-card mailer sheet construction, comprising:
(a) printing artwork on a portion of a web;
(b) calendering an edge of the web portion;
(c) forming on the web portion a plurality of perforation lines defining an outline of a combination postcard-card mailer separable therealong from the rest of the web portion after indicia has been applied to the mailer wherein at least one of the lines defines a perforation line between a postcard and a card of the combination mailer; and
(d) sheeting the web into a sheet which includes the web portion.

42. The method of claim 41 wherein the forming includes cutting the perforation lines in a direction parallel to the paper fibers at a first station with a first die cutting pressure and cutting the perforation lines in a direction perpendicular to the paper fibers at a second different station with a second greater die cutting pressure.

43. The method of claim 41 wherein the combination postcard-card mailer defines a first combination postcard-card mailer, the postcard defines a first postcard and the card defines a first card, and (c) includes the plurality of perforation lines defining an outline of a second combination postcard-card mailer separable therealong from the rest of the web portion after indicia has been applied to the second combination mailer wherein at least one of the lines defines a perforation line between a second postcard and a second card of the second combination mailer.

44. The method of claim 41 wherein the card defines a rectangular business card.

45. The method of claim 41 wherein the card defines a rotary card.
